(19) United States
(12) Patent Application Publication
(10) Pub. No.: US 2020/0193329 A1
(43) Pub. Date: Jun. 18, 2020

(54) LEARNING METHOD AND LEARNING APPARATUS

(71) Applicant: FUJITSU LIMITED, Kawasaki-shi (JP)

(72) Inventors: Takeshi OSOEKAWA, Ohta (JP); TAKASHI KATOH, Kawasaki (JP); Yusuke Hida, Atsugi (JP); Yuzi KANAZAWA, Setagaya (JP)

(73) Assignee: FUJITSU LIMITED, Kawasaki-shi (JP)

(21) Appl. No.: 16/713,965

(22) Filed: Dec. 13, 2019

(30) Foreign Application Priority Data
Dec. 18, 2018 (JP) 2018-236731

(51) Int. Cl. G06N 20/00

(52) U.S. Cl. CPC G06N 20/00

(57) ABSTRACT

A computer-implemented learning method includes inputting a plurality of pieces of input data and labels representing the plurality of pieces of input data into an encoder configured to output context variables associated with each of the plurality of pieces of input data, inputting the plurality of pieces of input data and the context variables output by the encoder into a decoder configured to output decision labels associated with the plurality of pieces of input data respectively, and learning parameters of the encoder and the decoder so that each of the decision labels matches with a corresponding label of the labels representing the plurality of the plurality of pieces of input data.

### CROSS-REFERENCE TO RELATED APPLICATION

This application is based upon and claims the benefit of priority of the prior Japanese Patent Application No. 2018-236731, flied on Dec. 18, 2018, the entire contents of which are incorporated herein by reference.

### FIELD

The embodiments discussed herein are related to a learning technology.

### BACKGROUND

In machine learning, learning target data may include a plurality of contexts in some cases. For example, data used for marketing automation (MA) and data used in a case where a handwritten character string is recognized include a plurality of contexts.

In MA, when a general name of a wanted product is accepted, a product matched with a user's taste is recommended based on a past purchase history. For example, in a case where it is found that a user searches for a “black ballpoint pen”, a “black ballpoint pen emphasizing an inexpensive price”, a “black ballpoint pen emphasizing a famous manufacturer”, and a “black ballpoint pen emphasizing luxury” are recommended from the past purchase history.

The data used in a case where the handwritten character string is recognized may include the plurality of contexts due to a user's habit in some cases. FIG. 22 is a diagram illustrating an example of handwritten character string data. A character of data 6 illustrated in FIG. 22 is very similar to a Japanese character “ [symbol] ” written by a person A and a Japanese character “ [symbol] ” written by a person B. That is, for example, the data 6 includes a plurality of contexts.

In supervised machine learning in which a question is set as a feature amount and an answer is set as a label, when the plurality of contexts are included as described above, a state in which a plurality of different labels are associated with the same feature amount is not appropriately learnt, and accuracy is degraded.

For example, in a case where machine learning is performed by using the data including the plurality of contexts, countermeasures for performing learning exist by using a plurality of learning models corresponding to the respective contexts. When the “handwritten character” described in FIG. 22 is described as an example, leaning data in which the data 6 is set as the question and “ [symbol] ” is set as the answer is used to learn a first leaning model. Leaning data in which the data 6 is set as the question and “ [symbol] ” is set as the answer is used to learn a second leaning model.

Related-art techniques are disclosed in, for example, Japanese Laid-open Patent Publication Nos. 2013-109471, 2009-157951, 2017-37588, and 2015-26355.

### SUMMARY

According to an aspect of the embodiments, a computer-implemented learning method includes inputting a plurality of pieces of input data and labels representing the plurality of pieces of input data into an encoder configured to output context variables associated with each of the plurality of pieces of input data, inputting the plurality of pieces of input data and the context variables output by the encoder into a decoder configured to output decision labels associated with the plurality of pieces of input data respectively, and learning parameters of the encoder and the decoder so that each of the decision labels matches with a corresponding label of the labels representing the plurality of the plurality of pieces of input data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram (1) for describing processing in a learning phase according to the present Embodiment 1;

FIG. 2 is a diagram (2) for describing the processing in the learning phase according to the present Embodiment 1;

FIG. 3 is a diagram (1) for describing processing in a recognition phase according to the present Embodiment 1;

FIG. 4 is a diagram (2) for describing processing in the recognition phase according to the present Embodiment 1;

FIG. 5 is a diagram illustrating a system according to the present Embodiment 1;

FIG. 6 is a functional block diagram illustrating a configuration of a learning apparatus according to the present Embodiment 1;

FIG. 7 is a diagram illustrating an example of a data structure of an input data table according to the present Embodiment 1;

FIG. 8 is a diagram illustrating an example of a data structure of a label table according to the present Embodiment 1;

FIG. 9 is a diagram illustrating an example of a data structure of a correspondence table according to the present Embodiment 1;

FIG. 10 is a diagram illustrating an example of a data structure of a latent variable table according to the present Embodiment 1;

FIG. 11 is a functional block diagram illustrating a configuration of a recognition apparatus according to the present Embodiment 1;

FIG. 12 is a diagram illustrating an example of a data structure of a latent variable calculation table according to the present Embodiment 1;

FIG. 13 is a diagram (1) for describing processing of a latent variable specification unit;

FIG. 14 is a diagram (2) for describing the processing of the latent variable specification unit;

FIG. 15 is a flowchart illustrating a processing procedure of the learning apparatus according to the present Embodiment 1;

FIGS. 16A and 16B are a flowchart illustrating the processing procedure of the recognition apparatus according to the present Embodiment 1;

FIG. 17 is a functional block diagram illustrating a configuration of the learning apparatus according to the present Embodiment 2;

FIG. 18 is a diagram for describing processing of a learning unit according to the present Embodiment 2;

FIG. 19 is a flowchart illustrating the processing procedure of the learning apparatus according to the present Embodiment 2;

FIG. 20 is a diagram illustrating an example of a hardware configuration of a computer that realizes a function similar to that of the learning apparatus according to the present embodiment;

FIG. 21 is a diagram illustrating an example of the hardware configuration of the computer that realizes a function similar to that of the recognition apparatus according to the present embodiment; and

FIG. 22 is a diagram illustrating an example of handwritten character string data.

### DESCRIPTION OF EMBODIMENTS

In a related-art technology, an issue occurs that appropriate learning is not performed when input data includes a plurality of contexts. For example, when the above-mentioned countermeasures are used, in a case where leaning is performed by using new leaning data, it is decided on which leaning model the new leaning data belongs to among a plurality of leaning models, but it is difficult to perform the aforementioned decision, and the appropriate learning is not performed.

Hereinafter, embodiments of a learning program, a learning method, and a learning apparatus disclosed in the present application will be described in detail with reference to the drawings. It is noted that the present disclosure is not limited by the embodiments. Japanese characters are non-limiting examples in embodiments.

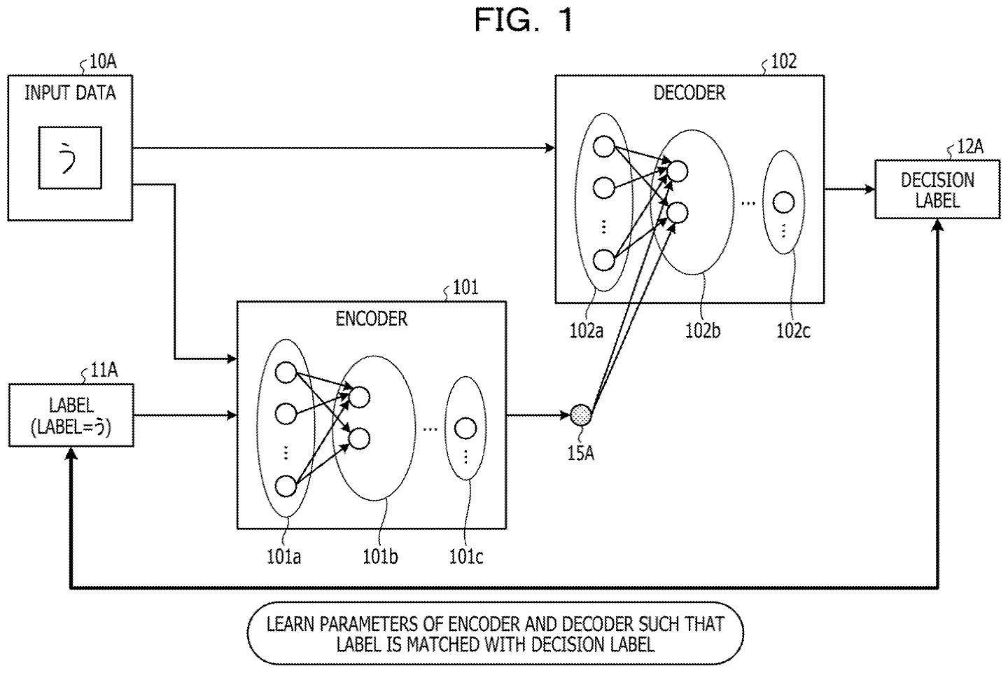

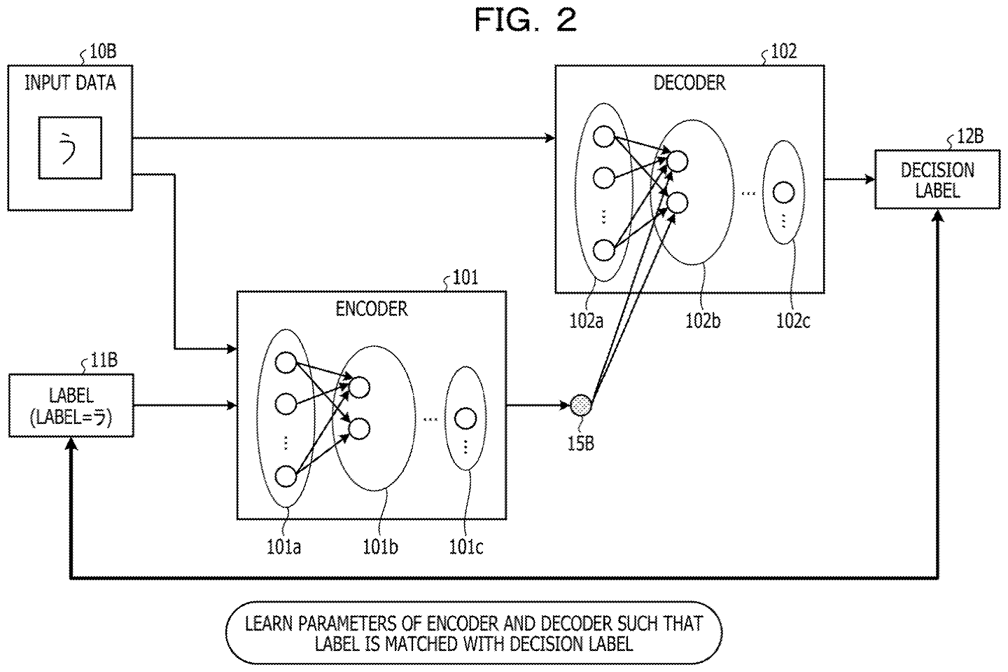

Processing in a learning phase performed by a learning apparatus according to the present Embodiment 1 will be described. FIG. 1 and FIG. 2 are diagrams for describing the processing in the learning phase according to the present Embodiment 1. The learning apparatus executes an encoder 101 and a decoder 102. In FIG. 1, a case will be described where parameters of the encoder 101 and the decoder 102 are learnt by using input data 10A of a handwritten character by a user A among a plurality of users.

The encoder 101 has a neural network data structure and includes an input layer 101a, a hidden layer 101b, and an output layer 101c. The input layer 101a and the hidden layer 101b constitute a structure in which a plurality of nodes are coupled to each other by edges. The hidden layer 101b and the output layer 101c have a function called an activating function and a bias value, and the edge has a weight.

The decoder 102 has a neural network data structure and includes an input layer 102a, a hidden layer 102b, and an output layer 102c. The input layer 102a and the hidden layer 102b constitute a structure in which a plurality of nodes are coupled to each other by an edge. The hidden layer 102b and the output layer 102c have a function called an activating function and a bias value, and the edge has a weight.

In the following explanation, the bias values, the weights, and the like appropriately set in the encoder 101 and the decoder 102 are collectively referred to as “parameters”.

The learning apparatus inputs the input data 10A and a label 11A to the input layer 101a of the encoder 101. The input data 10A is image data of the handwritten character by the user A. The label 11A indicates a correct label of the input data 10A. In the example illustrated in FIG. 1, the label 11A indicates that the handwritten character of the input data 10A is “ [symbol] ”.

When the learning apparatus inputs the input data 10A and the label 11A to the input layer 101a of the encoder 101, a multi-dimensional latent variable 15A is output from the output layer 101c of the encoder 101. This latent variable 15A indicates a habit (feature) in a case where the user A writes a character by hand. The number of dimensions of the latent variable 15A is matched with the number of nodes of the output layer 101c. For example, when the number of nodes of the output layer 101c is “2”, the number of dimensions of the latent variable 15A is “2”. The latent variable is an example of context variables.

The learning apparatus inputs the input data 10A to the input layer 102a of the decoder 102 and inputs the latent variable 15A to the hidden layer 102b of the decoder. As a result, a decision label 12A is output from the output layer 102c of the decoder 102. The decision label 12A indicates a prediction result (character recognition result) of the character handwritten in the input data 10A.

The learning apparatus learns the parameters of the encoder 101 and the parameters of the decoder 102 such that the label 11A is matched with the decision label 12A. For example, the learning apparatus learns the parameters by using a gradient method or the like such that a value of an evaluation function indicating a difference between the label 11A and the decision label 12A becomes the lowest.

Description continues with reference to FIG. 2. In FIG. 2, a case will be described where the parameters of the encoder 101 and the decoder 102 are learnt by using input data 10B of a handwritten character by a user B among the plurality of users.

The learning apparatus inputs the input data 10B and a label 11B to the input layer 101a of the encoder 101. The input data 10B is image data of the handwritten character by the user B. The label 11B indicates a correct label of the input data 10B. In the example illustrated in FIG. 2, the label 11B indicates that the handwritten character of the input data 10B is “ [symbol] ”.

When the learning apparatus inputs the input data 10B and the label 11B to the input layer 101a of the encoder 101, a multi-dimensional latent variable 15B is output from the output layer 101c of the encoder 101. This latent variable 15B indicates a habit (feature) in a case where the user B writes a character by hand.

The learning apparatus inputs the input data 10B to the input layer 102a of the decoder 102 and inputs the latent variable 15B to the hidden layer 102b of the decoder. As a result, a decision label 12B is output from the output layer 102c of the decoder 102. The decision label 12B indicates a prediction result (character recognition result) of the character handwritten in the input data 10B.

The learning apparatus learns the parameters of the encoder 101 and the parameters of the decoder 102 such that the label 11B is matched with the decision label 12B. For example, the learning apparatus performs the learning of the parameters by using the gradient method or the like such that a value of an evaluation function indicating a difference between the label 11B and the decision label 12B becomes the lowest.

The learning apparatus repeatedly executes the processing illustrated in FIG. 1 and FIG. 2 to learn the parameters of the encoder 101 and the decoder 102. The input data input to the encoder 101 and the decoder 102 by the learning apparatus may be input data of any user, but the label corresponds to the input data. That is, for example, as illustrated in FIG. 1, in a case where the learning is performed by using the input data 10A, the label 11A corresponding to the input data 10A is input to the encoder 101, the latent variable 15A of the user A is calculated to be input to the decoder 102, and the learning is performed. As illustrated in FIG. 2, in a case where the learning is performed by using the input data 10B, the label 11B corresponding to the input data 10B is input to the encoder 101, the latent variable 15B of the user B is calculated to be input to the decoder 102, and the learning is performed.

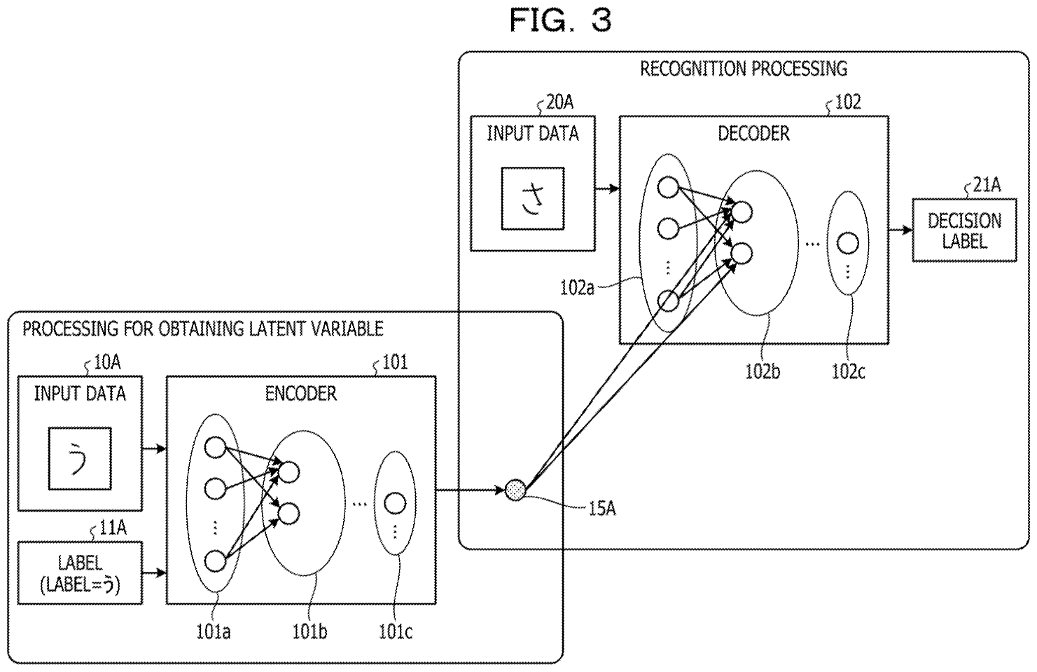

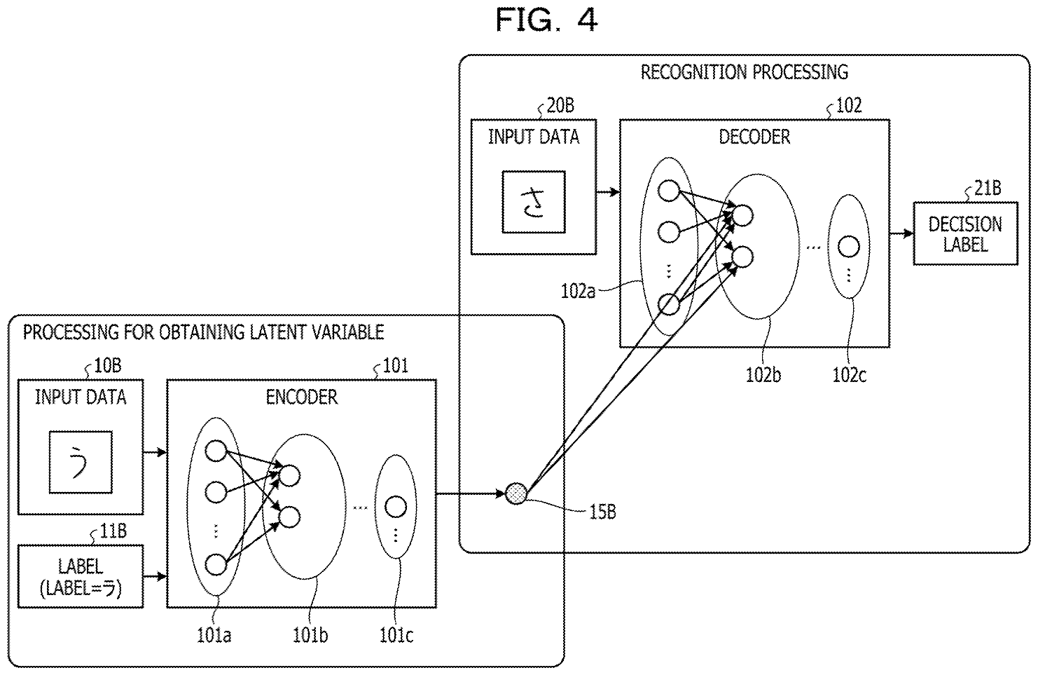

Processing in a recognition phase performed by a recognition apparatus according to the present Embodiment 1 will be described. FIG. 3 and FIG. 4 are diagrams for describing the processing in the recognition phase according to the present Embodiment 1. In FIG. 3, a case will be described as an example where input data 20A of a character written by the user A by hand is recognized.

The recognition apparatus executes the encoder 101 and the decoder 102. The parameters learnt by the learning apparatus in the learning phase described in FIG. 1 and FIG. 2 are used as the parameters set in the encoder 101 and the decoder 102.

The recognition apparatus performs processing for obtaining the latent variable of the user A in a case where the processing in the recognition phase is performed. The recognition apparatus inputs the input data 10A and the label 11A to the input layer 101a of the encoder 101 to calculate the latent variable 15A. This latent variable 15A indicates the habit (feature) in a case where the user A writes the character by hand.

When the latent variable 15A is obtained, the recognition apparatus shifts to the recognition processing. The recognition apparatus inputs the input data 20A set as a recognition target to the input layer 102a of the decoder 102 and inputs the latent variable 15A to the hidden layer 102b of the decoder 102. As a result, a decision label 21A is output from the output layer 102c of the decoder 102. In a case where the input data 20A is recognized, since the decoder 102 outputs the decision label 21A by also taking into account the latent variable 15A indicating the habit of the handwriting by the user A, it is possible to output the decision label 21A in conformity to the habit of the handwriting by the user A.

Description continues with reference to FIG. 4. In FIG. 4, a case will be described as an example where input data 20B of the character written by the user B by hand is recognized. The recognition apparatus executes the encoder 101 and the decoder 102. The parameters learnt by the learning apparatus in the learning phase described in FIG. 1 and FIG. 2 are used as the parameters set in the encoder 101 and the decoder 102.

The recognition apparatus performs processing for obtaining the latent variable of the user A in a case where the processing in the recognition phase is performed. The recognition apparatus inputs the input data 10B and the label 11B to the input layer 101a of the encoder 101 to calculate the latent variable 15B. This latent variable 15B indicates the habit (feature) in a case where the user B writes the character by hand.

When the latent variable 15B is obtained, the recognition apparatus shifts to the recognition processing. The recognition apparatus inputs the input data 20B set the a recognition target to the input layer 102a of the decoder 102 and inputs the latent variable 15B to the hidden layer 102b of the decoder 102. As a result, the decision label 21B is output from the output layer 102c of the decoder 102. In a case where the input data 20B is recognized, since the decoder 102 outputs the decision label 21B by also taking into account the latent variable 15B indicating the habit of the handwriting by the user B, it is possible to output the decision label 21B in conformity to the habit of the handwriting by the user B.

As described above, the learning apparatus according to the present Embodiment 1 inputs the input data and the label corresponding to this input data to the encoder 101 to calculate the latent variable. The learning apparatus learns the parameters of the encoder 101 and the decoder 102 such that the decision label in a case where the calculated latent variable and the input data are input to the decoder 102 is matched with the label. For this reason, even in a case where the input data includes a plurality of contexts, it is possible to perform the appropriate learning by using the latent variables corresponding to the plurality of contexts.

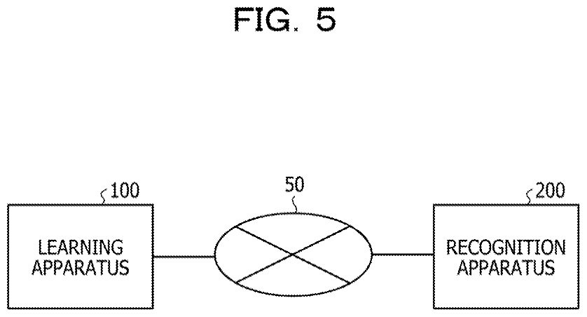

Next, an example of a system according to the present Embodiment 1 will be described. FIG. 5 is a diagram illustrating the system according to the present Embodiment 1. As illustrated in FIG. 5, this system includes a learning apparatus 100 and a recognition apparatus 200. The learning apparatus 100 and the recognition apparatus 200 are mutually coupled via a network 50.

The case where the learning apparatus 100 is coupled to the recognition apparatus 200 via the network 50 has been described as an example but is not limited to this. The learning apparatus 100 may be directly coupled to the recognition apparatus 200 by a wireless communication or a wired communication.

As described in FIG. 1, FIG. 2, and the like, the learning apparatus 100 is an apparatus that learns the parameters of the encoder 101 and the decoder 102 based on the input data and the label. The learning apparatus 100 notifies the recognition apparatus 200 of information of the learnt parameters.

As described in FIG. 3, FIG. 4, and the like, the recognition apparatus 200 is an apparatus that executes the encoder 101 and the decoder 102 by using the parameters notified of from the learning apparatus 100 and calculates the decision label corresponding to the input data of the recognition target by using the latent variable.

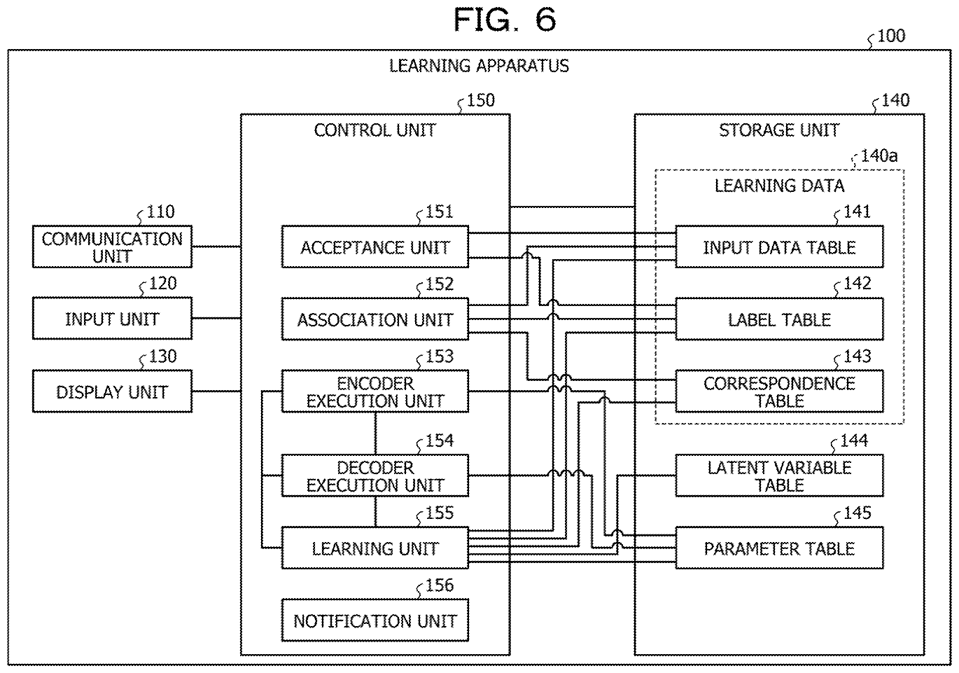

FIG. 6 is a functional block diagram illustrating a configuration of the learning apparatus according to the present Embodiment 1. As illustrated in FIG. 6, the learning apparatus 100 includes a communication unit 110, an input unit 120, a display unit 130, a storage unit 140, and a control unit 150.

The communication unit 110 is a processing unit that executes a data communication with the recognition apparatus 200 via the network 50. The communication unit 110 is an example of a communication apparatus. The control unit 150 described below exchanges data with the recognition apparatus 200 by using the communication unit 110.

The input unit 120 is an input device configured to input various data to the learning apparatus 100. The input unit 120 corresponds to a keyboard, a mouse, a touch panel, and the like. The input unit 120 may also be a handwriting input device (pen-input device). When the user performs handwriting input by using a dedicated pen, the handwriting input device generates input data (image data) of a trace of the handwriting input and inputs the input data to the learning apparatus 100.

The display unit 130 is a device that displays information of an event output from the control unit 150 and video data. The display unit 130 corresponds to a liquid crystal display, a touch panel, or the like.

The storage unit 140 includes learning data 140a, a latent variable table 144, and a parameter table 145. The learning data 140a includes an input data table 141, a label table 142, and a correspondence table 143. The storage unit 140 corresponds to a semiconductor memory element such as a random-access memory (RAM), a read-only memory (ROM), a flash memory, or a storage device such as a hard disk drive (HDD).

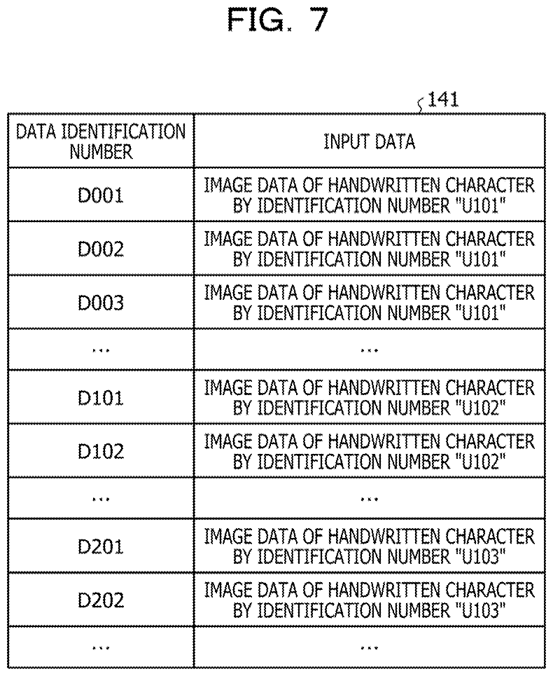

The input data table 141 is a table that holds various input data. FIG. 7 is a diagram illustrating an example of a data structure of the input data table according to the present Embodiment 1. As illustrated in FIG. 7, the input data table 141 associates a data identification number with input data. The data identification number is information for uniquely identifying the input data. The input data is image data of the handwritten character by the user. For example, pieces of the input data stored in the input data table 141 correspond to the input data 10A, 10B, and the like illustrated in FIG. 1 and FIG. 2.

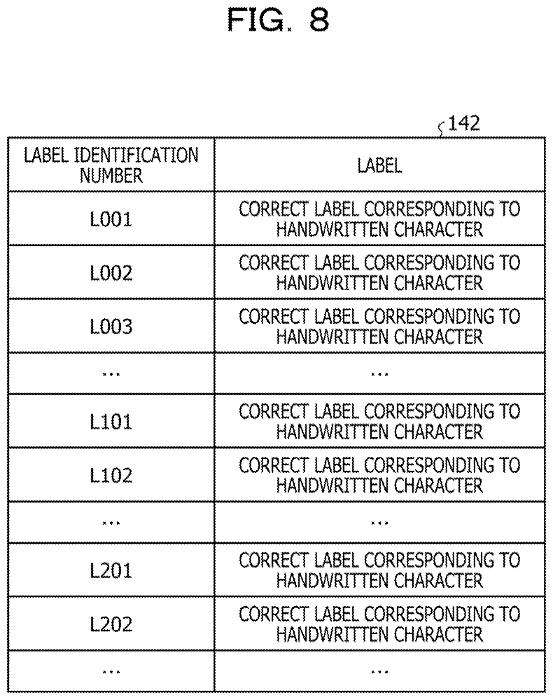

The label table 142 is a table that holds labels (correct labels) of the respective input data stored in the input data table 141. FIG. 8 is a diagram illustrating an example of a data structure of the label table according to the present Embodiment 1. As illustrated in FIG. 8, the label table 142 associates a label identification number with a label. The label identification number is information for uniquely identifying the label. The labels corresponds to the labels 11A, 11B, and the like illustrated in FIG. 1 and FIG. 2.

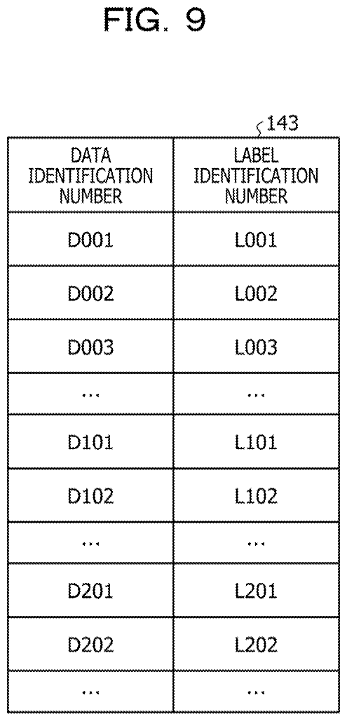

The correspondence table 143 is a table for defining a correspondence relationship between the input data and the label. FIG. 9 is a diagram illustrating an example of a data structure of the correspondence table according to the present Embodiment 1. As illustrated in FIG. 9, the correspondence table 143 associates the data identification number with the label identification number. For example, in the second row in FIG. 9, a data identification number “D001” is associated with a label identification number “L001”. For this reason, it is indicated that a correct label corresponding to the input data of the data identification number “D001” in the input data table 141 is the label identification number “L001” in the label table 142.

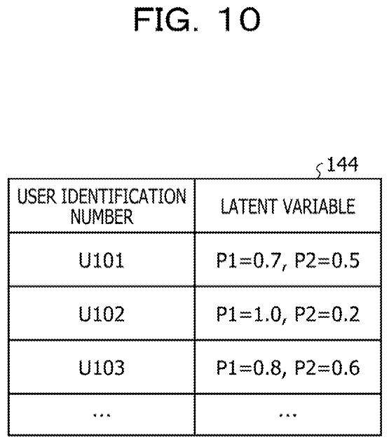

The latent variable table 144 is a table that holds latent variables of respective users which are calculated by the encoder 101. FIG. 10 is a diagram illustrating an example of a data structure of a latent variable table DB according to the present Embodiment 1. As illustrated in FIG. 10, the latent variable table 144 associates a user identification number with the latent variable. The user identification number is information for uniquely identifying a user. The latent variable is a numeric value representing a habit of the user identified by the user identification number. For example, the latent variable of the user identified by the user identification number “U101” is “P1=0.7, P2=05”.

The parameter table 145 is a table that holds the parameters of the encoder 101 and the decoder 102. For example, the parameters of the encoder 101 correspond to weights of edges that couple respective nodes of the input layer 101a, the hidden layer 101b, and the output layer 101c to each other and bias values set in the activating functions of the respective nodes.

For example, the parameters of the decoder 102 correspond to weights of edges that couple respective nodes of the input layer 102a, the hidden layer 102b, and the output layer 102c to each other and bias values set in the activating functions of the respective nodes.

FIG. 6 will be described again. The control unit 150 includes an acceptance unit 151, an association unit 152, an encoder execution unit 153, a decoder execution unit 154, a learning unit 155, and a notification unit 156. The control unit 150 is achieved by a central processing unit (CPU), a microprocessor unit (MPU), or the like. The control unit 150 may also be achieved by a hardwired logic circuit such as an application-specific integrated circuit (ASIC) or a field-programmable gate array (FPGA).

The acceptance unit 151 is a processing unit that accepts information of the input data table 141 and information of the label table 142 from an external apparatus (not illustrated), the input unit 120, or the like. When the information of the input data table 141 is accepted, the acceptance unit 151 stores the accepted information in the input data table 141. When the information of the label table 142 is accepted, the acceptance unit 151 stores the accepted information in the label table 142.

The association unit 152 is a processing unit that associates respective input data in the input data table 141 with respective labels in the label table 142 to generate the correspondence table 143. For example, the association unit 152 outputs the respective input data stored in the input data table 141 and the respective labels stored in the label table 142 to the display unit 130 and displayed. An administrator refers to the respective input data and the respective labels displayed in the display unit 130 and operates the input unit 120 to specify a pair of the input data and the label in the correspondence relationship. When the specification of the pair of the input data and the label is accepted via the input unit 120, the association unit 152 associates the data identification number with the label identification number corresponding to the specified pair to be registered in the correspondence table 143.

The association unit 152 may generate the correspondence table 143 by processing other than the aforementioned processing. The association unit 152 may also accept the information of the correspondence table 143 from the external apparatus (not illustrated), the input unit 120, or the like and store the accepted information of the correspondence table 143 in the correspondence table 143.

The encoder execution unit 153 is a processing unit that executes the encoder 101 illustrated in FIG. 1, FIG. 2, and the like. For example, the encoder execution unit 153 generates the input layer 101a, the hidden layer 101b, and the output layer 101c and couples the plurality of nodes included in the respective layers 101a to 101c by the edges. The encoder execution unit 153 sets the parameters of the encoder 101 as initial values when the learning phase is started. The initial values of the parameters of the encoder 101 are stored in the parameter table 145.

When the pair of the input data and the label is obtained from the learning unit 155, the encoder execution unit 153 inputs the input data and the label to the respective nodes of the input layer 101a of the encoder 101. For example, the encoder execution unit 153 divides the input data into a plurality of partial areas, extracts feature amounts for the respective partial areas, and inputs the feature amounts for the respective partial areas to the respective nodes of the input layer 101a.

The encoder execution unit 153 inputs the information corresponding to the label to the nodes of the input layer 101a. For example, when the label is information indicating that the handwritten character of the input data is “ [symbol] ”, the encoder execution unit 153 inputs information indicating that an element of a dimension corresponding to “ [symbol] ” becomes “1”, and an element of a dimension corresponding to another character becomes “0” to the nodes of the input layer 101a.

The encoder execution unit 153 inputs the input data and the label to the respective nodes of the input layer 101a of the encoder 101 and calculates a latent variable to be output from the output layer 101c of the encoder 101. The encoder execution unit 153 outputs the pair of the calculated latent variable and the input data input to the input layer 101a in a case where this latent variable is calculated to the decoder execution unit 154.

The decoder execution unit 154 is a processing unit that executes the decoder 102 illustrated in FIG. 1, FIG. 2, and the like, For example, the decoder execution unit 154 generates the input layer 102a, the hidden layer 102b, and the output layer 102c and couples the plurality of nodes included in the respective layers 102a to 102c by the edges. The decoder execution unit 154 sets the parameters of the decoder 102 as initial values when the learning phase is started. The initial values of the parameters of the decoder 102 are stored in the parameter table 145.

When the pair of the input data and the latent variable is obtained from the encoder execution unit 153, the decoder execution unit 154 inputs the input data to the respective nodes of the input layer 102a of the decoder 102 and inputs the latent variables to the respective nodes of the hidden layer 102b. For example, the decoder execution unit 154 divides the input data into a plurality of partial areas, extracts feature amounts for the respective partial areas, and inputs the feature amounts for the respective partial area to the respective nodes of the input layer 102a.

In a case where the latent variables are input to the respective nodes of the hidden layer 102b, the decoder execution unit 154 inputs numeric values corresponding to respective dimensions of the latent variable to the respective nodes. For example, the number of dimensions of the latent variable is two dimensions, and “P1=0.7, P2=0.5” is assumed. In this case, the decoder execution unit 154 inputs “P1=0.7” to one of the nodes of the hidden layer 102b and inputs “P2=0.5” to the other node of the hidden layer 102b.

The decoder execution unit 154 inputs the input data to the respective nodes of the input layer 102a, inputs the latent variable to the hidden layer 102b, and calculates the decision label output from the output layer 102c of the decoder 102. The respective nodes of the output layer 102c of the decoder 102 are allocated with respective characters. For example, the respective nodes of the output layer 102c are allocated with Japanese characters such as “ [symbol] ”, “ [symbol] ”, “ [symbol] ”, . . . , “ [symbol] ”, “ [symbol] ”, “ [symbol] ”, . . . , “ [symbol] ”, “ [symbol] ”, . . . . A numeric value output from each node of the output layer 102c indicates a probability of the character allocated to the node.

For example, in FIG. 1, in a case where the input data 10A and the latent variable 15A are input to the decoder 102, and the numeric value output from the node corresponding to “ [symbol] ” of the output layer 102c is “90”, it is indicated that the probability that the handwritten character of the input data 10A is “ [symbol] ” is “90%”. The case has been described where the numeric value output from each node is the probability, but the administrator may appropriately change the numeric value.

The decoder execution unit 154 outputs information of the decision label output from the output layer 102c to the learning unit 155. For example, the information of the decision label corresponds to a value of the probability output from each node of the output layer 102c of the decoder 102.

As described in FIG. 1, FIG. 2, and the like, the learning unit 155 is a processing unit that learns the parameters of the encoder 101 and the decoder 102 such that the label input to the encoder 101 is matched with the decision label output from the decoder 102. The learning unit 155 stores information of the learnt parameters in the parameter table 145.

An example of the processing of the learning unit 155 will be described below. The learning unit 155 refers to the correspondence table 143 and specifies the pair of the input data and the label corresponding to the input data from a relationship between the data identification number and the label identification number. The learning unit 155 obtains the specified input data from the input data table 141 and obtains the specified label from the label table 142. When the pair of the input data and the label is output to the encoder execution unit 153, the learning unit 155 causes the encoder execution unit 153 to calculate the latent variable. The pair of the input data and the latent variable is output from the encoder execution unit 153 to the decoder execution unit 154, and the decoder execution unit 154 calculates the information of the decision label.

The learning unit 155 learns the parameters of the encoder 101 and the decoder 102 such that the label information output to the encoder execution unit 153 is matched with the information of the decision label output from the decoder execution unit 154. The learning unit 155 updates the parameter table 145 with the learnt parameters.

The learning unit 155 updates the parameters of the encoder 101 and the decoder 102 such that a value of an evaluation function indicating a difference between the information of the decision label output from the output layer 102c of the decoder 102 and the information of the label becomes the lowest. In a case where the information of the label is “ [symbol] ”, the parameters of the encoder 101 and the decoder 102 are updated such that the probability of the character “ [symbol] ” becomes closer to “100%” in the information of the decision label.

The learning unit 155 refers to the correspondence table 143, obtains the input data and the label corresponding to the input data, and repeatedly executes the aforementioned processing to learn the parameters of the encoder 101 and the decoder 102 and update the parameter table 145.

When the aforementioned processing is performed, after the learning of the parameters of the encoder 101 and the decoder 102 is completed, the learning unit 155 may perform processing for generating information of the latent variable table 144.

The learning unit 155 obtains the input data of the user which is set as a calculation target of the latent variable and the label from the input data table 141 and the label table 142. Although not illustrated in the drawing, the learning unit 155 refers to the table in which the user identification number for identifying the user is associated with the data identification number for identifying the input data handwritten by the user and decides a relationship between the user and the input data.

The learning unit 155 outputs the obtained input data and the label to the encoder execution unit 153 and causes the encoder execution unit 153 to calculate the latent variable. The learning unit 155 stores the user identification number corresponding to the input data and the calculated latent variable in the latent variable table 144 while being associated with each other.

The learning unit 155 also executes the aforementioned processing with regard to another user and specifies the relationship between the user identification number and the latent variable to be stored in the latent variable table 144.

The notification unit 156 is a processing unit that notifies the recognition apparatus 200 of the information of the latent variable table 144 and the information of the parameter table 145.

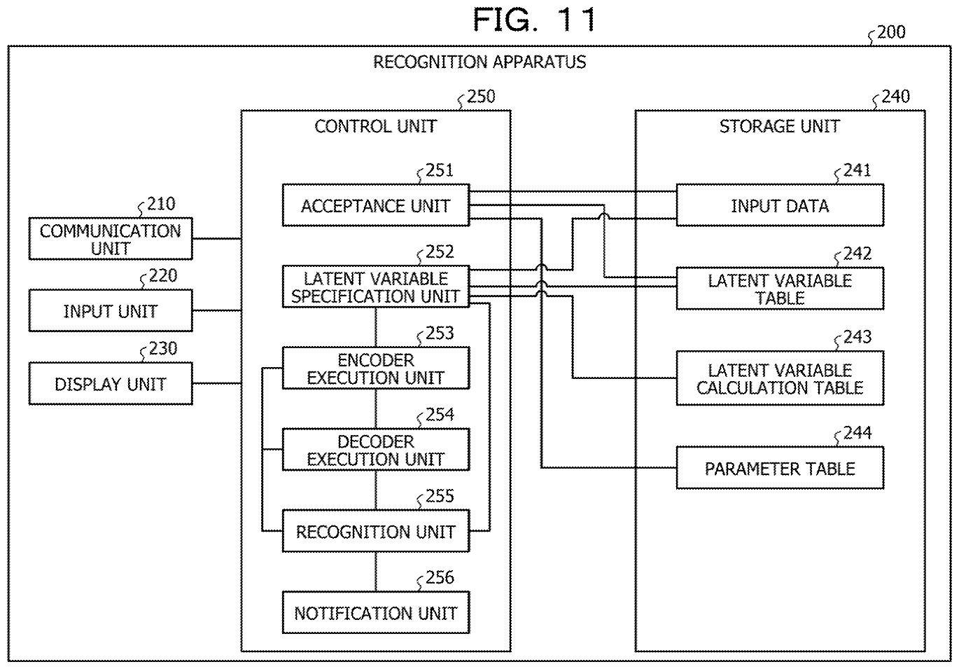

FIG. 11 is a functional block diagram illustrating a configuration of the recognition apparatus according to the present Embodiment 1. As illustrated in FIG. 11, the recognition apparatus 200 includes a communication unit 210, an input unit 220, a display unit 230, a storage unit 240, and a control unit 250.

The communication unit 210 is a processing unit that executes a data communication with the learning apparatus 100 via the network 50. The communication unit 210 is an example of a communication apparatus. The control unit 250 described below exchanges data with the learning apparatus 100 by using the communication unit 210.

The input unit 220 is an input device configured to input various data to the recognition apparatus 200. The input unit 220 corresponds to a keyboard, a mouse, a touch panel, and the like. The input unit 220 may also be a handwriting input device. When the user performs handwriting input by using a dedicated pen, the handwriting input device generates input data (image data) of a trace of the handwriting input and inputs the input data to the recognition apparatus 200.

The user operates the input unit 220 and inputs the input data to the recognition apparatus 200, and in a case where the recognition is executed, the user inputs the user identification number.

The display unit 230 is a device that displays information of an event output from the control unit 250 and video data. The display unit 230 corresponds to a liquid crystal display, a touch panel, or the like.

The storage unit 240 includes input data 241, a latent variable table 242, a latent variable calculation table 243, and a parameter table 244. The storage unit 240 corresponds to a semiconductor memory element such as a RAM, a ROM, a flash memory, or a storage device such as an HDD.

The input data 241 is input data set as a recognition target. According to the present Embodiment 1, the input data 241 is set as image data of a handwritten character as an example. The input data 241 corresponds to the input data 20A illustrated in FIG. 3 and the input data 20B illustrated in FIG. 4. The user identification number for identifying the user who has written the handwriting character of the input data may be associated with the input data 241.

The latent variable table 242 is a table that holds latent variables of respective users. The latent variable table 242 associates the user identification number with the latent variable. A data structure of the latent variable table 242 is similar to the data structure of the latent variable table 144 illustrated in 10.

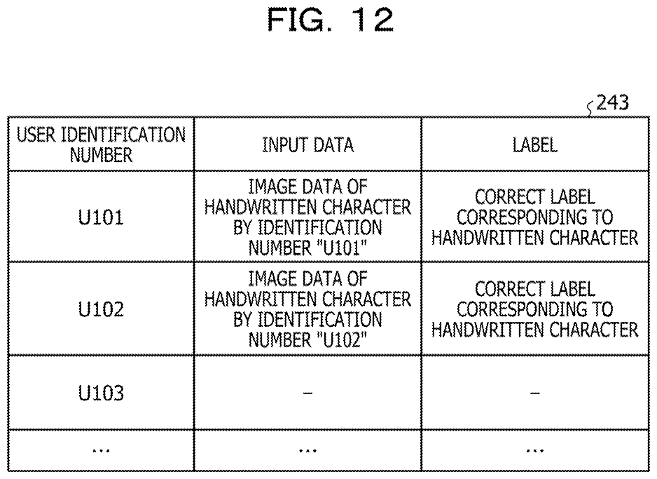

The latent variable calculation table 243 is a table that holds data used in a case where the latent variables of the users are derived. FIG. 12 is a diagram illustrating an example of a data structure of the latent variable calculation table according to the present Embodiment 1. As illustrated in FIG. 12, the latent variable table 243 associates the user identification number, the input data, and the label with one another. The user identification number is information for uniquely identifying a user. The input data is image data of the handwritten character input by the user corresponding to the user identification number. The label indicates a correct label of the input data.

The parameter table 244 is a table that holds pre-trained parameters of the encoder 101 and the decoder 102.

FIG. 11 will be described again. The control unit 250 includes an acceptance unit 251, a latent variable specification unit 252, an encoder execution unit 253, a decoder execution unit 254, a recognition unit 255, and a notification unit 256. The control unit 250 may be realized by a CPU, an MPU, or the like. The control unit 250 may also be realized by hard-wired logic such as ASIC and FPGA.

The acceptance unit 251 is a processing unit that accepts various data. When the input data 241 set as the recognition target is accepted from the input unit 220, the acceptance unit 251 stores the input data 241 in the storage unit 240. The acceptance unit 251 accepts the user identification number from the input unit 220 to be associated with the input data 241.

In a case where the information of the latent variable table 144 is received from the learning apparatus 100, the acceptance unit 251 stores the information of the latent variable table 144 in the latent variable table 242. In a case where the pre-trained parameters are received from the learning apparatus 100, the acceptance unit 251 stores the pre-trained parameters in the parameter table 244.

The latent variable specification unit 252 is a processing unit that specifies the latent variable corresponding to the user identification number. The latent variable specification unit 252 outputs information of the specified latent variable to the recognition unit 255. An example of the processing of the latent variable specification unit 252 will be described below.

The latent variable specification unit 252 detects the latent variable corresponding to the user identification number corresponding to the input data 241 from the latent variable table 242. In a case where the latent variable corresponding to the user identification number exists in the latent variable table 242, the latent variable specification unit 252 outputs the detected latent variable to the recognition unit 255.

On the other hand, in a case where the latent variable corresponding to the user identification number does not exist in the latent variable table 242, the latent variable specification unit 252 executes the following processing. The latent variable specification unit 252 detects the input data and the label corresponding to the user identification number from the latent variable calculation table 243.

In a case where the input data and the label corresponding to the user identification number exist in the latent variable calculation table 243, the latent variable specification unit 252 outputs the input data and the label to the encoder execution unit 253 to cause the encoder execution unit to execute the encoder 101 to calculate the latent variable. When the aforementioned processing is executed, the latent variable specification unit 252 obtains the latent variable corresponding to the user identification number from the encoder execution unit 253. The latent variable specification unit 252 stores the user identification number and the latent variable in the latent variable table 242 while being associated with each other. The latent variable specification unit 252 outputs the latent variable corresponding to the user identification number to the recognition unit 255.

On the other hand, in a case where the input data and the label corresponding to the user identification number do not exist in the latent variable calculation table 243, the latent variable specification unit 252 executes the following processing. The latent variable specification unit 252 outputs information of a latent variable setting screen to the display unit 230 to be displayed.

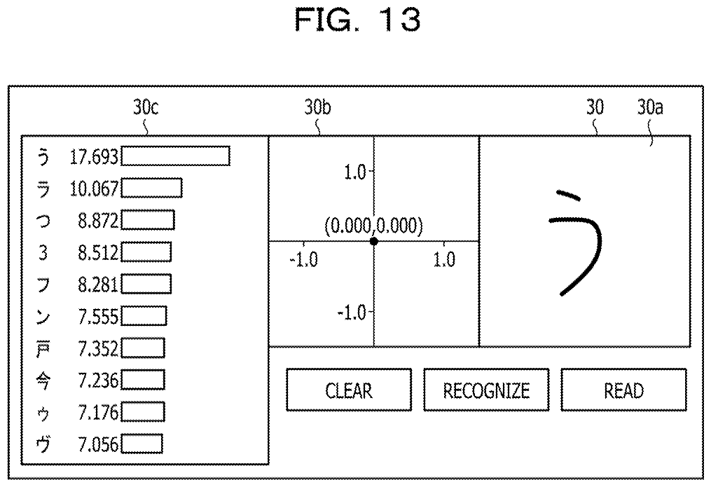

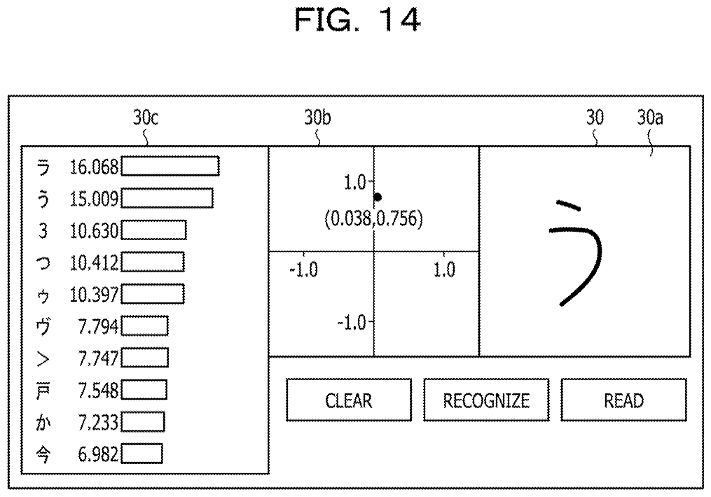

FIG. 13 and FIG. 14 are diagrams for describing the processing of the latent variable specification unit. As illustrated in FIG. 13, a latent variable setting screen 30 includes areas 30a, 30b, and 30c. The area 30a is an area where the user writes a handwritten character. The user operates the input unit 220 to write the character in the area 30a. The latent variable specification unit 252 obtains image data of the handwritten character in the area 30a as input data.

The area 30b is an area where a currently set latent variable is displayed. An initial value of the latent variable is set as (P1=0.0, P2=0.0). First, the latent variable specification unit 252 outputs the input data in the area 30a and the initial value of the latent variable to the recognition unit 255 to obtain information of the decision label. The area 30c is an area where the information of the decision label is displayed. The information of the decision label includes a recognition result of the handwritten character in the area 30a, and a probability of each character is displayed, for example.

The user refers to the area 30c in FIG. 13 and operates the input unit 220 to select the character intended by itself from the respective characters in the area 30c. In a case where the selected character is a character having the highest probability in the area 30c, the latent variable specification unit 252 stores the current latent variable (initial value) and the user identification number in the latent variable table 242 while being associated with each other. For example, in a case where the character “ [symbol] ” is selected from the respective characters in the area 30c, the latent variable specification unit 252 stores the user identification number of the user and the latent variable (P1=0.0, P2=0.0) in the latent variable table 242 while being associated with each other.

On the other hand, in a case where the selected character is a character other than the character having the highest probability in the area 30c, the latent variable specification unit 252 performs the following processing. The latent variable specification unit 252 outputs the pair of the label in which the selected character is correct and the input data corresponding to the handwritten character in the area 30a to the encoder execution unit 253 and causes the encoder execution unit to execute the encoder 101 to calculate the latent variable. For example, in a case where the character “ [symbol] ” is selected from the respective characters in the area 30c, the label in which “ [symbol] ” is correct and the input data in the area 30a are output to the encoder execution unit 253 to cause the encoder execution unit to execute the encoder 101 and calculate the latent variable.

Description continues with reference to FIG. 14. The latent variable specification unit 252 displays the latent variable obtained from the encoder execution unit 253 in the area 30b. In an example illustrated in FIG. 14. the latent variable is set as (P1=0.038, P2=0.756). The latent variable specification unit 252 outputs the latent variable calculated by the encoder execution unit 253 and the input data in the area 30a to the recognition unit 255 to obtain information of the decision label. The latent variable specification unit 252 updates the area 30c with the information of the decision label newly obtained from the recognition unit 255.

The user refers to the area 30c in FIG. 14 and operates the input unit 220 to select the character intended by itself from the respective characters in the area 30c. In a case where the selected character is a character having the highest probability in the area 30c, the latent variable specification unit 252 stores the current latent variable and the user identification number in the latent variable table 242 while being associated with each other. On the other hand, in a case where the selected character is a character other than the character having the highest probability in the area 30c, the latent variable specification unit 252 repeatedly executes the aforementioned processing.

When the aforementioned processing is executed, the latent variable specification unit 252 specifies the latent variable that more appropriately indicates the habit of the user corresponding to the user identification number.

FIG. 11 will be described again. The encoder execution unit 253 is a processing unit that executes the encoder 101 illustrated in FIG. 1, FIG. 2, and the like. For example, the encoder execution unit 253 generates the input layer 101a, the hidden layer 101b, and the output layer 101c and couples the plurality of nodes included in the respective layers 101a to 101c to each other by the edges. The encoder execution unit 253 sets the pre-trained parameters stored in the parameter table 244 in the encoder 101.

In a case where the input data and the label are obtained from the latent variable specification unit 252, the encoder execution unit 253 inputs the input data and the label to the respective nodes of the input layer 101a of the encoder 101 to calculate the latent variable. The encoder execution unit 253 outputs the calculated latent variable to the latent variable specification unit 252.

The decoder execution unit 254 is a processing unit that executes the decoder 102 illustrated in FIG. 1, FIG. 2, and the like. For example, the decoder execution unit 254 generates the input layer 102a, the hidden layer 102b, and the output layer 102c and couples the plurality of nodes included in the respective layers 102a to 102c to each other by the edges. The decoder execution unit 254 sets the pre-trained parameters stored in the parameter table 244 in the decoder 102.

When the pair of the input data and the latent variable is obtained from the recognition unit 255, the decoder execution unit 254 inputs the input data to the respective nodes of the input layer 102a of the decoder 102 and inputs the latent variables to the respective nodes of the hidden layer 102b. As a result, the decoder execution unit 254 calculates the decision label output from the output layer 102c of the decoder 102. The decoder execution unit 254 outputs the information of the decision label to the recognition unit 255.

When the latent variable corresponding to the user identification number and the input data of the recognition target are accepted from the latent variable specification unit 252, the recognition unit 255 outputs the pair of the latent variable and the input data to the decoder execution unit 254 to obtain the information of the decision label. The recognition unit 255 outputs the information of the decision label to the notification unit 256.

On the other hand, with regard to the processing described in FIG. 13 and FIG. 14, when the latent variable corresponding to the area 30b and the input data corresponding to the area 30a are accepted from the latent variable specification unit 252, the recognition unit 255 outputs the pair of the latent variable and the input data to the decoder execution unit 254 to obtain the information of the decision label. The recognition unit 255 outputs the information of the decision label to the latent variable specification unit 252.

The notification unit 256 is a processing unit that performs notification of the information of the decision label obtained from the recognition unit 255. The notification unit 256 may also output the information of the decision label to the display unit 230 to be displayed or notify an external apparatus (not illustrated) coupled via the network 50 of the information of the decision label.

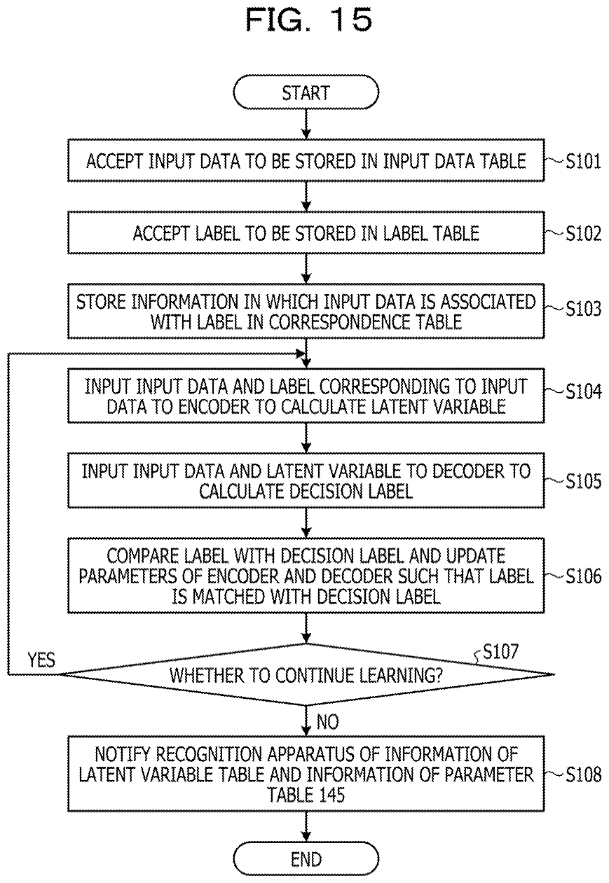

Next, an example of a processing procedure by the learning apparatus 100 according to the present Embodiment 1 will be described. FIG. 15 is a flowchart illustrating the processing procedure of the learning apparatus according to the present Embodiment 1. As illustrated in FIG. 15, the acceptance unit 151 of the learning apparatus 100 accepts the input data to be stored in the input data table 141 (step S101). The acceptance unit 151 accepts the input data to be stored in the label table 142 (step S102).

The association unit 152 of the learning apparatus 100 stores the information in which the input data is associated with the label in the correspondence table 143 (step S103). The encoder execution unit 153 of the learning apparatus 100 inputs the input data and the label corresponding to this input data to the encoder 101 to calculate the latent variable (step S104).

The decoder execution unit 154 of the learning apparatus 100 inputs the input data and the latent variable to the decoder 102 to calculate the decision label (step S105). The learning unit 155 of the learning apparatus 100 compares the label (correct label) with the decision label and updates the parameters of the encoder 101 and the decoder 102 such that the label is matched with the decision label (step S106).

In a case where the learning continues (step S107, Yes), the learning apparatus 100 proceeds to step S104. On the other hand, in a case where the learning does not continue (step S107, No), the learning apparatus 100 proceeds to step S108.

The notification unit 156 of the learning apparatus 100 notifies the recognition apparatus 200 of the information of the latent variable table 144 and the information of the parameter table 145 (step S108).

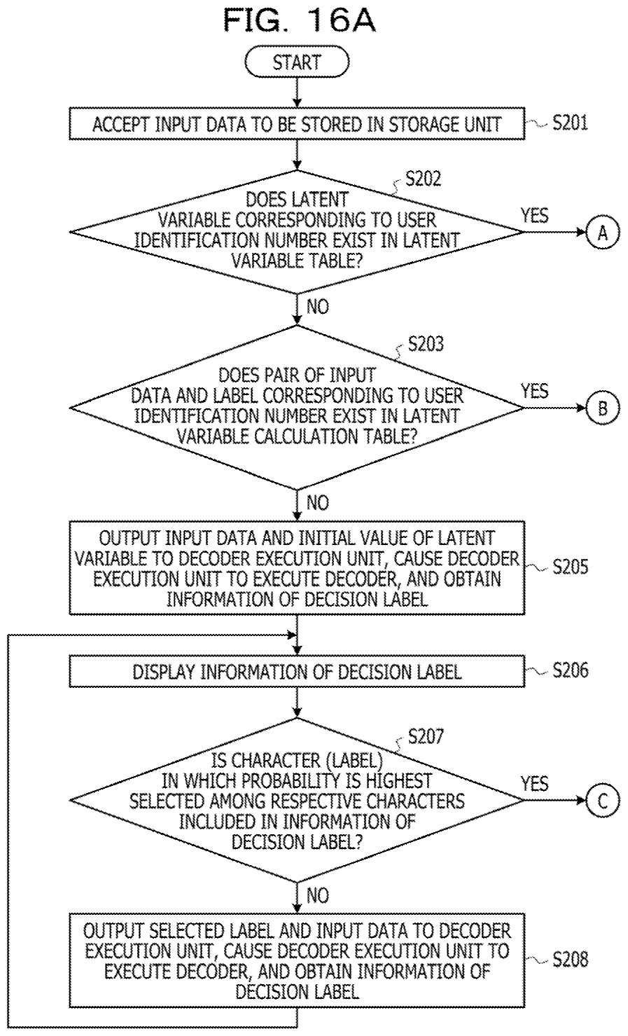

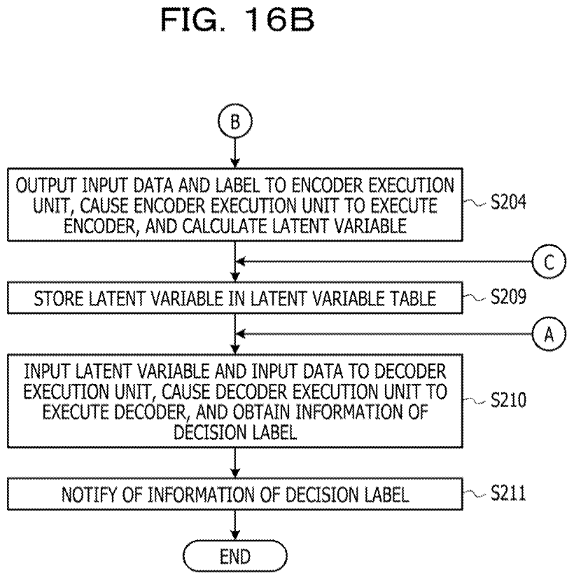

Next, an example of a processing procedure by the recognition apparatus 200 according to the present Embodiment 1 will be described. FIGS. 16A and 16B are a flowchart illustrating the processing procedure of the recognition apparatus according to the present Embodiment 1. As illustrated in FIGS. 16A and 16B, the acceptance unit 251 of the recognition apparatus 200 accepts the input data to be stored in the storage unit 240 (step S201).

The latent variable specification unit 252 of the recognition apparatus 200 decides whether or not the latent variable corresponding to the user identification number exists in the latent variable table 242 (step S202). In a case where the latent variable corresponding to the user identification number exists in the latent variable table 242 (step S202, Yes), the latent variable specification unit 252 proceeds to step S210.

On the other hand, in a case where the latent variable corresponding to the user identification number does not exist in the latent variable table 242 (step S202, No), the latent variable specification unit 252 proceeds to step S203.

The latent variable specification unit 252 decides whether or not the pair of the input data and the label corresponding to the user identification number exists in the latent variable calculation table 243 (step S203). In a case where the pair of the input data and the label corresponding to the user identification number exists in the latent variable calculation table 243 (step S203, Yes), the latent variable specification unit 252 proceeds to step S204.

The latent variable specification unit 252 outputs the input data and the label to the encoder execution unit 253 and causes the encoder execution unit to execute the encoder 101 to calculate the latent variable (step S204) and proceeds to step S209.

On the other hand, in a case where the pair of the input data and the label corresponding to the user identification number does not exist in the latent variable calculation table 243 (step S203, No), the latent variable specification unit 252 proceeds to step S205.

The latent variable specification unit 252 outputs the input data and the initial value of the latent variable to the decoder execution unit 254 and causes the decoder execution unit to execute the decoder 102 to obtain the information of the decision label (step S205). The latent variable specification unit 252 displays the information of the decision label of the latent variable setting screen 30 (step S206).

In a case where a character (label) having the highest probability among the respective characters included in the information of the decision label is selected (step S207, Yes), the latent variable specification unit 252 proceeds to step S209.

On the other hand, in a case where the character (label) having the highest probability among the respective characters included in the information of the decision label is not selected (step S207, No), the latent variable specification unit 252 outputs the selected label and the input data to the decoder execution unit 254 and causes the decoder execution unit to execute the decoder to obtain the information of the decision label (step S208) and proceeds to step S206.

The latent variable specification unit 252 stores the latent variable in the latent variable table (step S209). The recognition unit 255 of the recognition apparatus 200 inputs the latent variable and the input data to the decoder execution unit 254 and causes the decoder execution unit to execute the decoder 102 to obtain the information of the decision label (step S210). The notification unit 256 of the recognition apparatus 200 notifies the external apparatus of the information of the decision label (step S211).

The following describes effects achieved by the learning apparatus 100 according to the present Embodiment 1. The learning apparatus 100 inputs the input data and the label corresponding to this input data to the encoder 101 to calculate the latent variable. The learning apparatus 100 learns the parameters of the encoder 101 and the decoder 102 such that the decision label in a case where the calculated latent variable and the input data are input to the decoder 102 is matched with the label (correct label). For this reason, in accordance with the learning apparatus 100, even in a case where the input data includes a plurality of contexts, it is possible to perform the appropriate learning by using the latent variables corresponding to the plurality of contexts.

The processing executed by the latent variable specification unit 252 described in FIG. 13 and FIG. 14 may also be executed at a side of the learning apparatus 100. That is, for example, the learning apparatus 100 may also have a function similar to the latent variable specification unit 252.

According to the present Embodiment 1, the case where the learning apparatus 100 and the recognition apparatus 200 are implemented in separated apparatuses has been described as an example but is not limited to this. For example, the learning apparatus 100 may have the respective functions of the recognition apparatus 200 described in FIG. 11, and one apparatus may execute the processing of the learning apparatus 100 and the recognition apparatus 200.

Next, the learning apparatus 100 according to the present Embodiment 2 will be described. Although not illustrated in the drawing, the learning apparatus according to the present Embodiment 2 is coupled to the recognition apparatus 200 described in Embodiment 1 via the network 50.

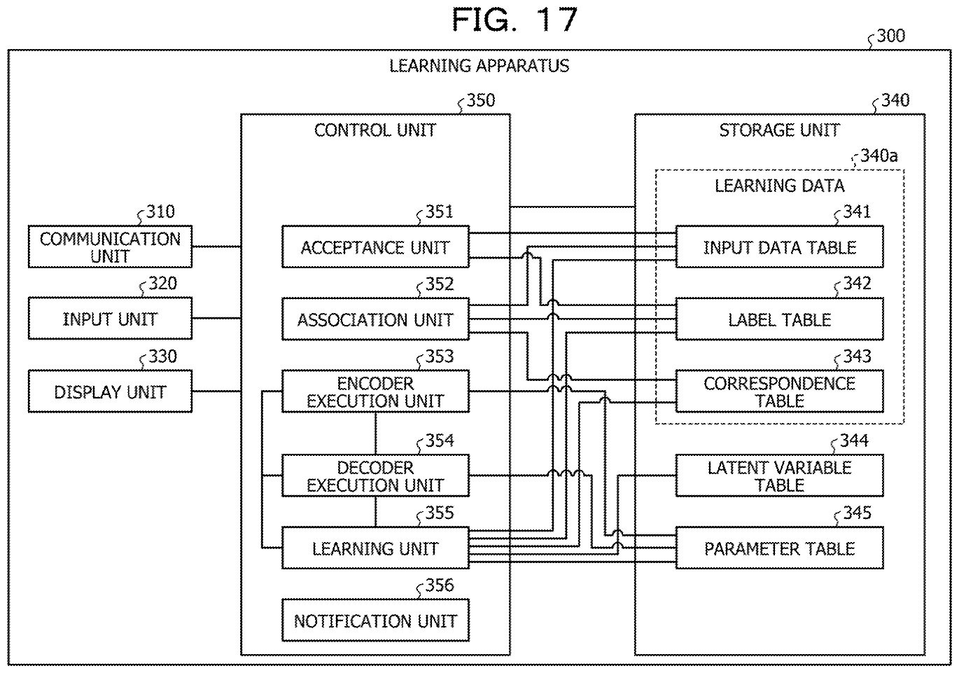

FIG. 17 is a functional block diagram illustrating a configuration of the learning apparatus according to the present Embodiment 2. As illustrated in FIG. 17, a learning apparatus 300 includes a communication unit 310, an input unit 320, a display unit 330, a storage unit 340, and a control unit 350.

The description regarding the communication unit 310, the input unit 320, and the display unit 330 is similar to the description regarding the communication unit 110, the input unit 120, and the display unit 130 described in FIG. 6.

The storage unit 340 includes learning data 340a, a latent variable table 344, and a parameter table 345. The learning data 340a includes an input data table 341, a label table 342, and a correspondence table 343. The storage unit 340 corresponds to a semiconductor memory element such as a RAM, a ROM, a flash memory, or a storage device such as an HDD.

The input data table 341 is a table that holds various input data. A data structure of the input data table 341 is similar to the description regarding the data structure of the input data table 141 described in FIG. 7.

The label table 342 is a table that holds labels (correct labels) of the respective input data stored in the input data table 341. A data structure of the label table 342 is similar to the description regarding the data structure of the label table 142 described in FIG. 8.

The correspondence table 343 is a table in which a correspondence relationship between the input data and the label is defined. A data structure of the correspondence table 343 is similar to the description regarding the data structure of the correspondence table 143 described in FIG. 9.

The latent variable table 344 is a table that holds latent variables of the respective users which are calculated by the encoder 101. A data structure of the latent variable table 344 according to the present Embodiment 2 is similar to the description regarding the data structure of the latent variable table 144 described in FIG. 10. However, the dimension of the latent variable stored in the latent variable table 344 becomes “n dimensions”. Where n is a natural number equal to or greater than 2. The dimension of the latent variable stored in the latent variable table 344 is extended until a redundant feature appears.

The parameter table 345 is a table that holds the parameters of the encoder 101 and the decoder 102. For example, the parameters of the encoder 101 correspond to weights of edges that couple respective nodes of the input layer 101a, the hidden layer 101b, and the output layer 101c to each other and bias values set in the activating functions of the respective nodes.

For example, the parameters of the decoder 102 correspond to weights of edges that couple respective nodes of the input layer 102a, the hidden layer 102b, and the output layer 102c to each other and bias values set in the activating functions of the respective nodes.

The control unit 350 includes an acceptance unit 351, an association unit 352, an encoder execution unit 353, a decoder execution unit 354, a learning unit 355, and a notification unit 356. The control unit 350 may be realized by a CPU, an MPU, or the like. The control unit 350 may also be realized by hard-wired logic such as ASIC and FPGA.

The acceptance unit 351 is a processing unit that accepts information of the input data table 341 and information of the label table 342 from an external apparatus (not illustrated), the input unit 320, or the like. When the information of the input data table 341 is accepted, the acceptance unit 351 stores the accepted information in the input data table 341. When the information of the label table 342 is accepted, the acceptance unit 351 stores the accepted information in the label table 342.

The association unit 352 is a processing unit that associates respective input data in the input data table 341 with respective labels in the label table 342 to generate the correspondence table 343. The other description regarding the association unit 352 is same as description regarding the association unit 152 described in Embodiment 1.

The encoder execution unit 353 is a processing unit that executes the encoder 101 illustrated in FIG. 1, FIG. 2, and the like. For example, the encoder execution unit 353 generates the input layer 101a, the hidden layer 101b, and the output layer 101c and couples the plurality of nodes included in the respective layers 101a to 101c to each other by the edges. The encoder execution unit 353 executes the processing in the learning phase similarly as in the encoder execution unit 153 described in Embodiment 1.

In a case where the encoder execution unit 353 executes the encoder 101, the number of nodes of the output layer 101c is set as 2, and the two-dimensional latent variable is calculated. When a control signal for increasing the dimension of the latent variable is accepted, the encoder execution unit 353 increases the number of nodes of the output layer 101c by 1 (extending the dimensions of the latent variable), re-couples the edges of the respective layers of the encoder 101, and executes the processing in the learning phase again to calculate the latent variable. Each time the control signal is accepted, the encoder execution unit 353 repeatedly executes the aforementioned processing.

The decoder execution unit 354 is a processing unit that executes the decoder 102 illustrated in FIG. 1, FIG. 2, and the like. For example, the decoder execution unit 354 generates the input layer 102a, the hidden layer 102b, and the output layer 102c and couples the plurality of nodes included in the respective layers 102a to 102c to each other by the edges. The decoder execution unit 354 executes the processing in the learning phase similarly as in the decoder execution unit 154 described in Embodiment 1.

In a case where the encoder execution unit 353 extends the dimensions of the latent variable, the decoder execution unit 354 increases the number of nodes of the hidden layer 102b at an input destination of the latent variable, re-couples the edges of the respective layers of the decoder 102, and executes the processing in the learning phase again.

As described in FIG. 1, FIG. 2, and the like, the learning unit 355 is a processing unit that learns the parameters of the encoder 101 and the decoder 102 such that the label input to the encoder 101 is matched with the decision label output from the decoder 102. The learning unit 355 stores information of the learnt parameters in the parameter table 345. The processing of the learning unit 355 in the learning phase is similar to the processing of the learning unit 155 described in Embodiment 1.

In a stage where the learning phase is ended, the learning unit 355 notifies the display unit or the external apparatus (not illustrated) of the information of the latent variable calculated by the encoder 101 and performs a query about whether or not the dimension of the latent variable is increased. In a case where the information indicating that the dimension of the latent variable is increase is accepted from the input unit 120 or the external apparatus (not illustrated), the learning unit 355 outputs the control signal to the encoder execution unit 353 and causes encoder execution unit to calculate the latent variable having the increased dimensions again. The learning unit 355 may decide whether or not the dimension of the current latent variable is increased in accordance with a predetermined decision policy instead of performing the query about whether or not the dimension of the latent variable is increased and output the control signal to the encoder execution unit 353 in a case where it is decided that the dimension of the latent variable is increased.

In a case where a plurality of pairs of the input data and the label corresponding to one user identification number exist, the learning unit 355 may execute the following processing and calculate the latent variable corresponding to the user identification number.

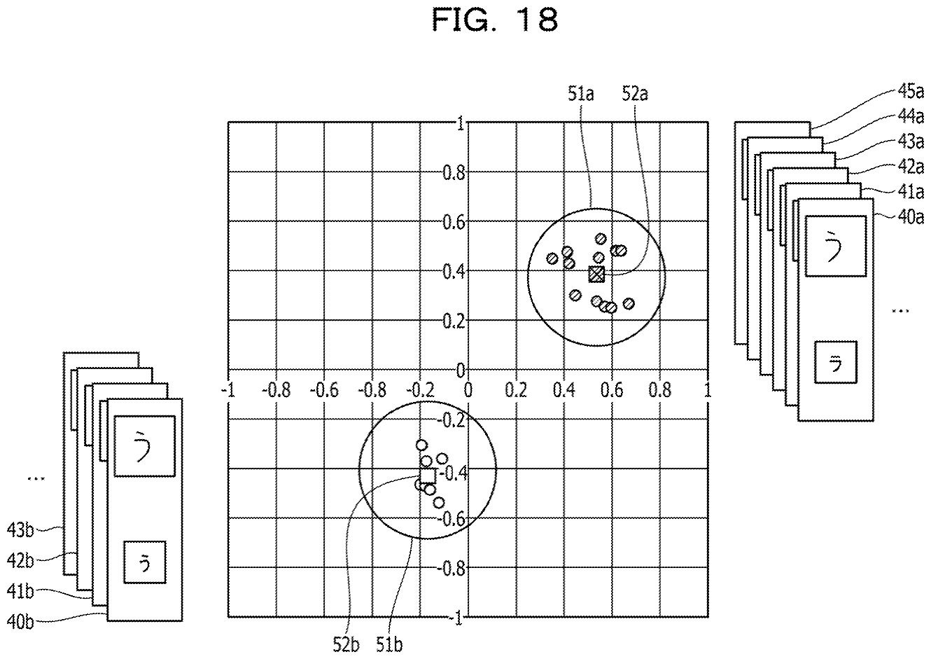

FIG. 18 is a diagram for describing the processing of the learning unit according to Embodiment 2. For example, it is assumed that pairs 40a to 45a of input data corresponding to a user identification number “U101” and a label exist. Although not illustrated in the drawing, a pair of input data and a label other than the pairs 40a to 45a may also exist. The learning unit 355 respectively outputs the respective pairs 40a to 45a to the encoder execution unit 353 and respectively calculates respective latent variables 51a corresponding to the respective pairs. The learning unit 355 calculates an average value 52a of the respective latent variables 51a as the latent variable corresponding to the user identification number “U101” to be stored in the latent variable table 344.

For example, it is assumed that pairs 40b to 43b of input data and a label corresponding to a user identification number “U102” exist. Although not illustrated in the drawing, a pair of input data and a label other than the pairs 40b to 43b may also exist. The learning unit 355 respectively outputs the respective pairs 40b to 43b to the encoder execution unit 353 and respectively calculates respective latent variables 51b corresponding to the respective pairs. The learning unit 355 calculates an average value 52b of the respective latent variables Sib as the latent variable corresponding to the user identification number “U102” to be stored in the latent variable table 344.

The notification unit 356 is a processing unit that notifies the recognition apparatus 200 of information of the latent variable table 344 and information of the parameter table 345.

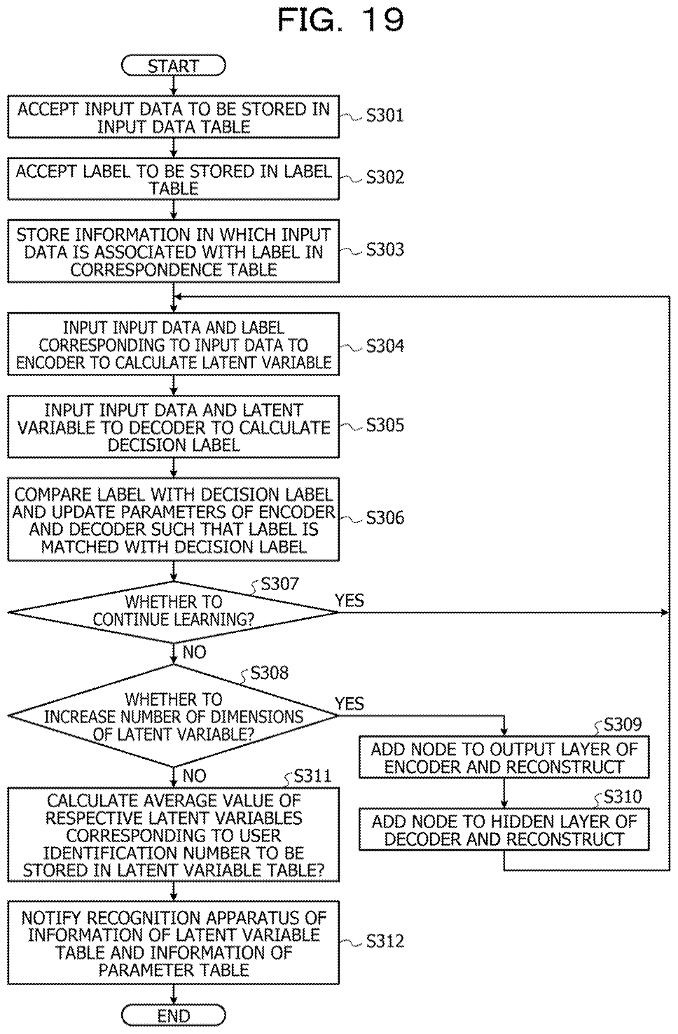

Next, an example of a processing procedure by the learning apparatus 300 according to the present Embodiment 2 will be described. FIG. 19 is a flowchart illustrating the processing procedure of the learning apparatus according to the present Embodiment 2. As illustrated in FIG. 19, the acceptance unit 351 of the learning apparatus 300 accepts the input data to be stored in the input data table 341 (step S301). The acceptance unit 351 accepts the input data to be stored in the label table 342 (step S302).

The association unit 352 of the learning apparatus 300 stores information in which the input data is associated with the label in the correspondence table 343 (step S303). The encoder execution unit 353 of the learning apparatus 300 inputs the input data and the label corresponding to this input data to the encoder 101 to calculate the latent variable (step S304).

The decoder execution unit 354 of the learning apparatus 300 inputs the input data and the latent variable to the decoder 102 to calculate the decision label (step S305). The learning unit 355 of the learning apparatus 300 compares the label (correct label) with the decision label and updates the parameters of the encoder 101 and the decoder 102 such that the label is matched with the decision label (step S306).

In a case where the learning continues (step S307, Yes), the learning apparatus 300 proceeds to step S304. On the other hand, in a case where the learning does not continue (step S307, No), the learning apparatus 300 proceeds to step S308.

The learning unit 355 decides whether or not the number of dimensions of the latent variable is increased (step S308). In a case where the number of dimensions of the latent variable is increased (step S308, Yes), the learning unit 355 proceeds to step S309. The encoder execution unit 353 adds the node to the output layer 101c of the encoder 101 to reconstruct (step S309). The decoder execution unit 354 adds the node to the hidden layer 102b of the decoder 102 to reconstruct (step S310). After that, the learning apparatus 300 proceeds to step S304.

On the other hand, in a case where the dimension of the latent variable is not increased (step S308, No), the learning unit 355 calculates the average value of the respective latent variables corresponding to the user identification number to be stored in the latent variable table 344 (step S311). The notification unit 356 of the learning apparatus 300 notifies the recognition apparatus 200 of the information of the latent variable table 344 and the information of the parameter table 345 (step S312).

The following describes effects achieved by the learning apparatus 300 according to the present Embodiment 2. In a case where a control instruction is accepted from the learning unit 355, the encoder execution unit 353 of the learning apparatus 300 executes processing for increasing the dimension of the latent variable by adding the node to the output layer 101c of the encoder 101. According to this, it is possible to more finely set the latent variable indicating the user's habit, and an accuracy in authentication processing using the aforementioned latent variable may be improved.

In a case where a plurality of pairs of the input data and the label corresponding to one user identification number exist, the learning unit 355 of the learning apparatus 300 respectively calculates latent variables obtained by inputting the respective pairs of the input data and the label to the encoder 101. The learning unit 355 calculates an average value of the plurality of latent variables corresponding to one user identification number as the latent variable corresponding to the user identification number to be stored in the latent variable table 344. When the aforementioned processing is executed, it is possible to more finely set the latent variable indicating the user's habit.

According to the present Embodiment 2, the case where the learning apparatus 300 and the recognition apparatus 200 are implemented in separated apparatuses has been described as an example but is not limited to this. For example, the learning apparatus 300 may have the respective functions of the recognition apparatus 200 described in FIG. 11, and one apparatus may execute the processing of the learning apparatus 300 and the recognition apparatus 200.

The case where the learning apparatuses 100 and 300 described in the present Embodiments 1 and 2 perform the learning by using the pair of the input data of the handwritten character and the label has been described but is not limited to this. For example, learning may be performed by using a pair of a question including a plurality of contexts (input data) and an answer (label).

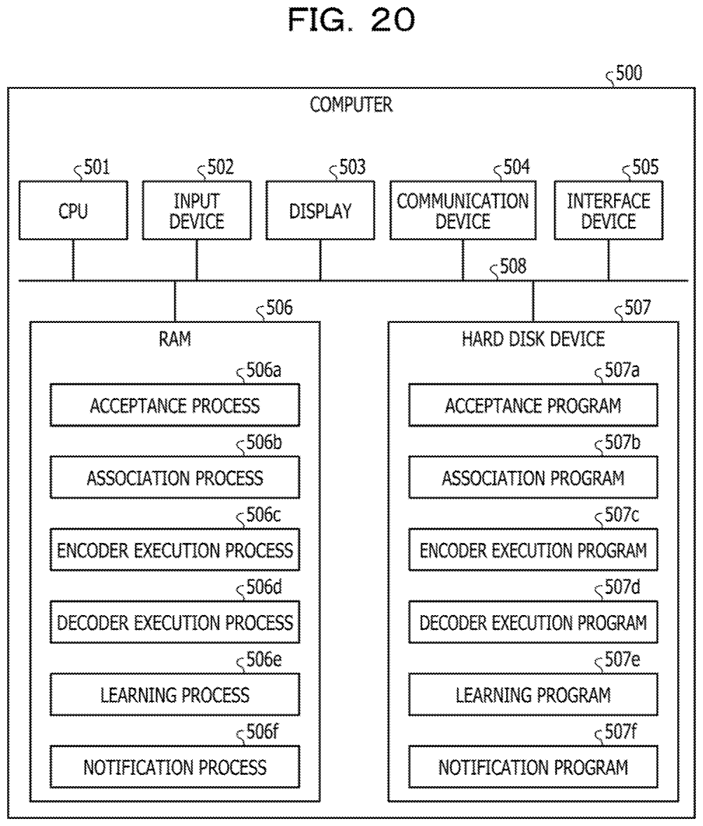

Next, an example of a hardware configuration of a computer that realizes the same functions as those of the learning apparatus 100 (300) and the recognition apparatus 200 illustrated in Embodiments will be described. FIG. 20 is a diagram illustrating an example of a hardware configuration of the computer that realizes the function similar to that of the learning apparatus according to the present embodiment.

As illustrated in FIG. 20, a computer 500 includes a CPU 501 that executes various arithmetic processing, an input device 502 that accepts input of data from the user, and a display 503. The computer 500 also includes a reading device 504 that reads a program or the like from a storage medium and an interface device 505 that exchanges data with the external apparatus, the recognition apparatus 200, or the like via a wired or wireless network. The computer 500 also includes a RAM 506 that temporarily stores various kinds of information and a hard disk device 507. The respective devices 501 to 507 are coupled to one another by a bus 508.

The hard disk device 507 includes an acceptance program 507a, an association program 507b, an encoder execution program 507c, a decoder execution program 507d, a learning program 507e, and a notification program 507f. The CPU 501 reads the acceptance program 507a, the association program 507b, the encoder execution program 507c, the decoder execution program 507d, the learning program 507e, and the notification program 507f to be loaded into the RAM 506.

The acceptance program 507a functions as an acceptance process 506a. The association program 507b functions as an association process 506b. The encoder execution program 507c functions as an encoder execution process 506c. The decoder execution program 507d functions as a decoder execution process 506d. The learning program 507e functions as a learning process 506e. The notification program 507f functions as a notification process 506f.

The processing of the acceptance process 506a corresponds to the processing of the acceptance units 151 and 351. The processing of the association process 506b corresponds to the processing of the association units 152 and 352. The processing of the encoder execution process 506c corresponds to the processing of the encoder execution units 153 and 353. The processing of the decoder execution process 506d corresponds to the processing of the decoder execution units 154 and 354. The processing of the learning process 506e corresponds to the processing of the learning units 155 and 355. The processing of the notification process 506f corresponds to the processing of the notification units 156 and 356.

The programs 507a to 507f do not necessarily have to be stored in the hard disk device 507 from the beginning. For example, the respective programs may be stored in a “portable physical medium” that is to be inserted in the computer 500, such as a flexible disk (FD), a compact disc read-only memory (CD-ROM), a digital versatile disc (DVD), a magneto-optical disc, or an IC card. The computer 500 may read and execute the respective programs 507a to 507f.

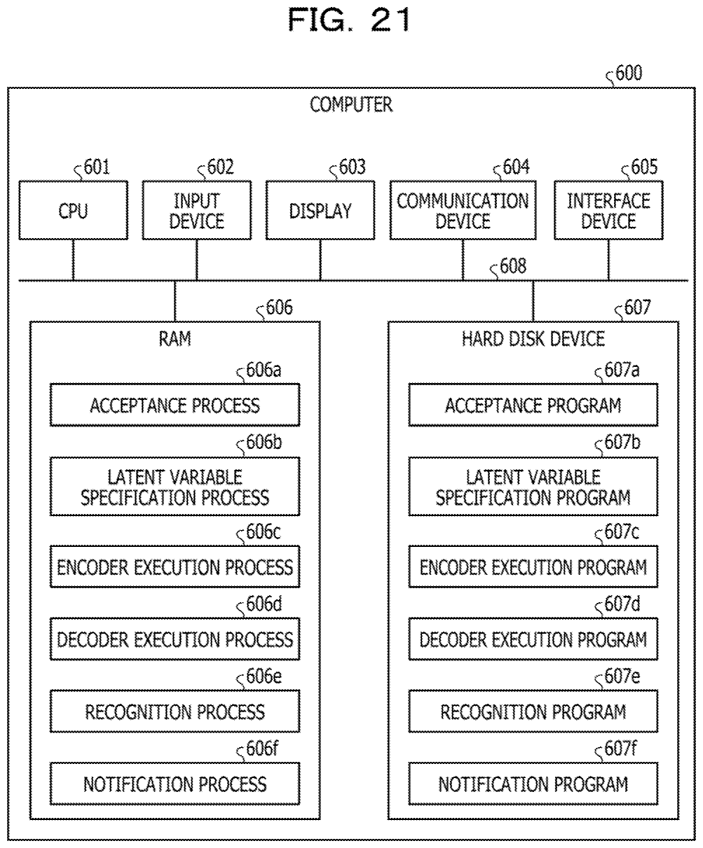

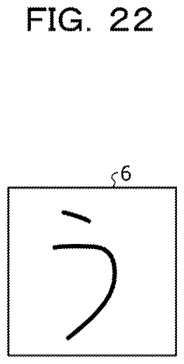

FIG. 21 is a diagram illustrating an example of the hardware configuration of the computer that realizes the function similar to that of the recognition apparatus according to the present embodiment. As illustrated in FIG. 21, a computer 600 includes a CPU 601 that executes various arithmetic processing, an input device 602 that accepts input of data from the user, and a display 603. The computer 600 also includes a reading device 604 that reads a program or the like from a storage medium and an interface device 605 that exchanges data with the external apparatus or the like via a wired or wireless network. The computer 600 also includes a RAM 606 that temporarily stores various kinds of information and a hard disk device 607. The respective devices 601 to 607 are coupled to one another by a bus 608.

The hard disk device 607 includes an acceptance program 607a, a latent variable specification program 607b, an encoder execution program 607c, a decoder execution program 607d, a recognition program 607e, and a notification program 607f. The CPU 601 reads the acceptance program 607a, the latent variable specification program 607b, the encoder execution program 607c, the decoder execution program 607d, the recognition program 607e, and the notification program 607f to be loaded into the RAM 606.

The acceptance program 607a functions as an acceptance process 606a. The latent variable specification program 607b functions as a latent variable specification process 606b. The encoder execution program 607c functions as an encoder execution process 606c. The decoder execution program 607d functions as a decoder execution process 606d. The recognition program 607e functions as a recognition process 606e. The notification program 607f functions as a notification process 606f.

The processing of the acceptance process 606a corresponds to the processing of the acceptance unit 251. The processing of the latent variable specification process 606b corresponds to the processing of the latent variable specification unit 252. The processing of the encoder execution process 606c corresponds to the processing of the encoder execution unit 253. The processing of the decoder execution process 606d corresponds to the processing of the decoder execution unit 254. The processing of the recognition process 606e corresponds to the processing of the recognition unit 255. The processing of the notification process 606f corresponds to the processing of the notification unit 256.

The respective programs 607a to 607f do not necessarily have to be stored in the hard disk device 607 from the beginning. For example, the respective programs may be stored in a “portable physical medium” that is to be inserted in the computer 600, such as a flexible disk (FD), a CD-ROM, a DVD, a magneto-optical disc, or an IC card. The computer 600 may read and execute the respective programs 607a to 607f.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-implemented learning method comprising:
inputting a plurality of pieces of input data and labels representing the plurality of pieces of input data into an encoder configured to output context variables associated with each of the plurality of pieces of input data;
inputting the plurality of pieces of input data and the context variables output by the encoder into a decoder configured to output decision labels associated with the plurality of pieces of input data respectively; and
learning parameters of the encoder and the decoder so that each of the decision labels matches with a corresponding label of the labels representing the plurality of the plurality of pieces of input data.

2. The learning method according to claim 1, wherein
the encoder includes an output layer including a plurality of nodes configured to output the context variables, and
the encoder is configured to, in response to receiving a control instruction, increase a number of the plurality of nodes in the output layer for increasing a number of the context variables to be output.

3. The learning method according to claim 1, wherein
the plurality of pieces of input data includes a first piece of input data,
the labels includes a first label representing first piece of input data and a second label representing the first piece of input data, and
the context variables associated with the first piece of input data is calculated based on first context variables associated with a combination of the first piece of input data and the first label, and second context variables associated with a combination of the first piece of input data and the second label.

4. The learning method according to claim 3, wherein
the context variables associated with the first piece of input data are average values of the first context variables and the second context variables.

5. A learning apparatus comprising:
a memory; and
a processor coupled to the memory and the processor configured to:
input a plurality of pieces of input data and labels representing the plurality of pieces of input data into an encoder configured to output context variables associated with each of the plurality of pieces of input data,
input the plurality of pieces of input data and the context variables output by the encoder into a decoder configured to output decision labels associated with the plurality of pieces of input data respectively, and
learn parameters of the encoder and the decoder so that each of the decision labels matches with a corresponding label of the labels representing the plurality of the plurality of pieces of input data.

6. The learning apparatus according to claim 5, wherein
the encoder includes an output layer including a plurality of nodes configured to output the context variables, and
the encoder is configured to, in response to receiving a control instruction, increase a number of the plurality of nodes in the output layer for increasing a number of the context variables to be output.

7. The learning apparatus according to claim 5, wherein
the plurality of pieces of input data includes a first piece of input data,
the labels includes a first label representing first piece of input data and a second label representing the first piece of input data, and
the context variables associated with the first piece of input data is calculated based on first context variables associated with a combination of the first piece of input data and the first label, and second context variables associated with a combination of the first piece of input data and the second label.

8. The learning apparatus according to claim 7, wherein
the context variables associated with the first piece of input data are average values of the first context variables and the second context variables.

9. A non-transitory computer-readable medium storing a learning program executable by one or more computers, the learning program comprising:
one or more instructions for inputting a plurality of pieces of input data and labels representing the plurality of pieces of input data into an encoder configured to output context variables associated with each of the plurality of pieces of input data;
one or more instructions for inputting the plurality of pieces of input data and the context variables output by the encoder into a decoder configured to output decision labels associated with the plurality of pieces of input data respectively; and
one or more instructions for learning parameters of the encoder and the decoder so that each of the decision labels matches with a corresponding label of the labels representing the plurality of the plurality of pieces of input data.
